(19) United States
(12) Patent Application Publication
(10) Pub. No.: US 2011/0231522 A1
(43) Pub. Date: Sep. 22, 2011

(54) DISTRIBUTED DIGITAL MEDIA METERING & REPORTING SYSTEM

(75) Inventors: Mark Knight, London (GB); Philip Sant, London (GB); Michael Lamb, London (GB); Mark Sullivan, Birmingham (GB); Stephen Pocock, Egham (GB); Lucien Rawden, London (GB); Alexander West, Edinburgh (GB)

(73) Assignee: Omnifone Limited, London (GB)

(21) Appl. No.: 13/060,125

(22) PCT Filed: Aug. 28, 2009
(86) PCT No.: PCT/GB2009/051091

§ 371 Date: May 24, 2011

(30) Foreign Application Priority Data
Aug. 28, 2008 (GB) 0815651.5

(51) Int. Cl. G06F 15/16

(52) U.S. Cl. 709/219

(57) ABSTRACT

A distributed digital media metering and reporting system makes available digital media files for multiple consumer devices from a computer-based infrastructure. The consumer devices meter the number of playbacks of a media file that last beyond a predefined extent, in order to generate metering data, and then automatically report that metering data back to the computer-based infrastructure.

### BACKGROUND OF THE INVENTION

1. Field of the Invention

This invention relates to a distributed digital media metering and reporting system; the system meters the use of digital media files, such as digital music tracks.

2. Description of the Prior Art

On-line, web-based music store, such as iTunes, have become the dominant mechanism for consumers to obtain media files, such as music and video tracks. But these typically work on a pay per track downloaded basis—i.e. you pay to download the music track or video file, but can then listen/view as often as you like; in particular, there is no feedback to the computer-based infrastructure (e.g. servers) supplying the media files of any metering or measurement data relating to whether the tracks you have downloaded are in fact played back, or the extent to any such playback.

### BRIEF SUMMARY OF THE INVENTION

The present invention is a method of metering the use of digital media files, comprising the steps of:
(a) making available digital media files for multiple consumer devices from a computer-based infrastructure;
(b) a consumer device metering the number of playbacks of a media file that last beyond a predefined extent, in order to generate metering data;
(c) that consumer device then automatically reporting that metering data back to the computer-based infrastructure.

In an implementation of the present invention, we monitor actual plays of a media file that last beyond a certain extent and automatically share that information with the computer-based infrastructure that supplied the media file. This is better because it gives much richer data concerning the files that are really of interest to the listening public and hence can allow the technical infrastructure that provides the downloads (e.g. handling and delivery of media files) to be optimised.

For example, top 20 charts are normally based on downloads. Say two different tracks are both downloaded 10,000 times in a week. Both would be given the same position in a weekly chart. But say one track was played twice as often as the other—we can measure that and hence support that track with more technical resources, such as greater server capacity and higher priority downloads so that later consumers of that track get a better download experience and the technical resources of the music download infrastructure and utilised more efficiently.

Tracks that are downloaded soon after release but played very heavily by the first wave of listeners are also more likely to be hits than those that are not played so heavily; more technical resources can then be made available for those potential hit tracks—for example, more server capacity, prioritised downloading, more prominence in on-line music sites visited by potential listeners etc. The ‘track play’ information can also be used for accounting and reporting purposes at the infra-structure side.

The metering data can be used to automatically:
identify tracks which are not present on a digital media service for a given locale.
identify tracks for further processing, where the further processing involves identifying a need for the ingestion of additional or updated metadata for one or more tracks, or provisioning one or more tracks to a user using a different digital media file format. The different digital media file format can either utilise a form of DRM protection or no such DRM protection.
recommend further media content to a specific user, where the metrics gathered about that user's media playing preferences are used to assist with calculations as to the user's likely preferences for watching, reading or listening to digital media content in the future.

The predefined extent of the playback can be configurable; it can be sufficiently long to distinguish a user playing a track from a user skipping past tracks.

Another aspect of the invention is a system for metering the use of digital media files, including:
(a) a computer-based infrastructure making available digital media files for multiple consumer devices;
(b) a consumer device programmed with software to (i) meter the number of playbacks of a media file that last beyond a predefined extent, in order to generate metering data and to then (ii) automatically report that metering data back to the computer-based infrastructure.

### BRIEF DESCRIPTION OF THE DRAWINGS

FIG. 1 depicts schematically the overall architecture of a system that implements automated content ingestion and preparation;

FIG. 2 is a more detailed schematic breakdown of the system that implements automated content ingestion and preparation;

FIG. 3 is a view of the process flow of content through the system;

FIG. 4 is an overview of the entire system, including metering and reporting components as defined by this invention.

### DETAILED DESCRIPTION OF THE INVENTION

In the preferred embodiment, there is a content ingestion engine that includes a highly scalable and adaptable content ingestion services framework. The ingestion services framework supports a full double-byte character set throughout and can ingest and prepare content for any part of the world in any character set including APAC territories. Content is ingested directly from the digital catalogues of the four major labels, the world's largest Indies and from major music content aggregators.

The enterprise-class content ingestion service framework enables the rapid integration of new content sources and quickly facilitates service deployment in new territories. The framework supports the rapid visual and programmatic building of new ingestion connections dealing with multiple transport mechanisms, handshakes and metadata formats. Automatic verification, validation and loading of content and metadata is supported, along with integration into third-party content metadata sources (e.g. Muze™, AGM™, Gracenote™) for value added validation and verification.

In-built process monitoring is supported, to ensure correct operations and completion of scheduled task cycles, while integrated monitoring and alerting exception conditions are provided for high process visibility and response.

There are many challenges in the area of content ingestion and consolidation, such as:
Resolving the huge duplication of artists, albums and tracks in existing data stores.
Music labels re-release albums many times, for example to drive sales, to celebrate landmark events or for releases in different territories. The same artist is known differently against different releases. Tracks are often duplicated from the many versions of singles, albums and other releases available.
When multiple artists contribute to a release they are rarely all correctly attributed. This limits the power of an online system's ability to navigate through the works performed by favourite artists.
In many situations services need to support Parental Advisory/Explicit metadata flags in order to protect consumers. Whilst some labels provide a reasonable coverage most do not and this data needs to be collated from multiple sources and supported by proactive and reactive human processes.

An implementation of the present invention resolves all of these issues via a sophisticated suite of data cleansing tools and human supported processes.

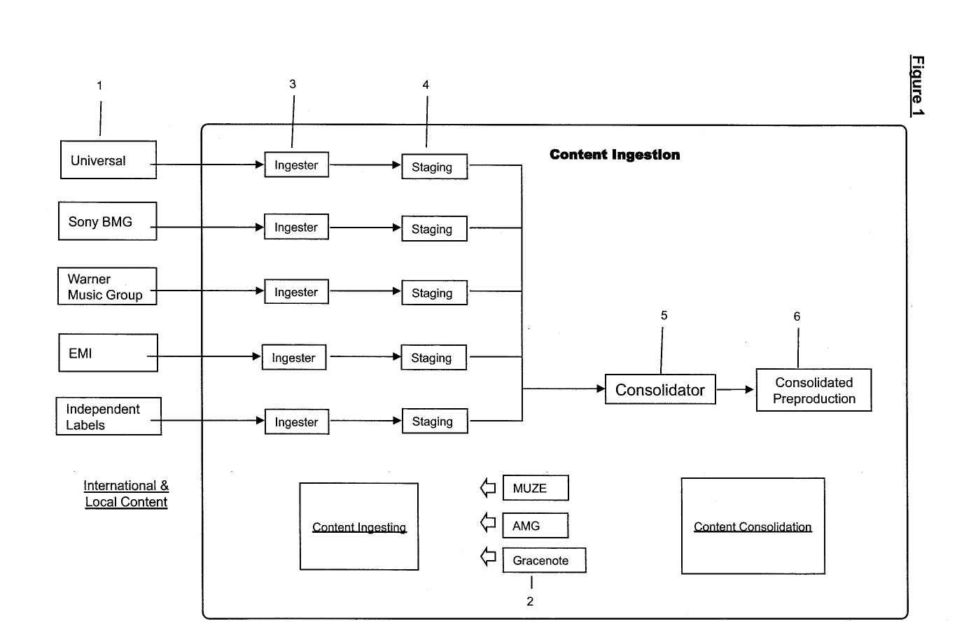

FIG. 1 illustrates the overall path of the data, from various data sources 1 (music labels, content aggregators, etc), integration with third party metadata sources 2, through loading/ingester areas 3, staging areas 4 for data cleansing/initial de-dupe and then the consolidation and de-duplication (Consolidator box 5) of the various sources into the single pre-production database 6 for testing prior to distribution via the production database (not illustrated).

After the cleansing and consolidation of music catalogues from multiple sources, the content files themselves need preparation and management so that the content provided by a service is compatible with and relevant to the plethora of devices which will access it.

Delivery of services to multiple devices on multiple platforms requires the content to be available in many formats, such as AAC+, eAAC+, WMA and MP3, in assorted bitrates, as required for a specific device or territory or as a result of a particular contractual obligation. Sometimes the final content format is available from the music label, sometimes the format needs to be created (transcoded) from a high quality reference version.

Different platforms have different Digital Rights Management solutions (e.g. Windows DRM™, OmniPlay™, OMAv2™, PlayReady™) Content files also have different containers/wrappers which are particular to different platforms.

Before publishing music content into a live service various checks need to be performed. Including:
Accurate metadata and physical content resources need to have been prepared correctly.
Publishing rights need to be confirmed by territory before release.

An implementation of the present invention provides the infrastructure and services required to achieve all of these goals and deliver a highly capable multi-device, multi-platform unlimited download music content service.

The stages of the overall process are:

### Content Deduplication

Cleanse incoming content
Artist deduplication
Release deduplication

### Artist Assignment

Correctly attribute artists to releases
Allows correct primary artist assignment and supporting artist linking and searching
Genre maintenance

### Adult Content

Confirm explicit metadata from labels
Manual visual inspection
External metadata checks and cross references (Muze™, AGM™ & Gracenote™)

### Content Preparation

Automated verification and transcoding of content assets
Confirm if final format content file delivered from labels
Validate final format file structure and container
Perform transcode where final format not available from source
Parallel transcode cluster for horsepower and throughput
Manage DRM encoding and content file wrapping/containers
Marshall content assets out to content delivery services

### Content Publishing

Publishing content and rights management

### Data Cleansing and De-Duplication

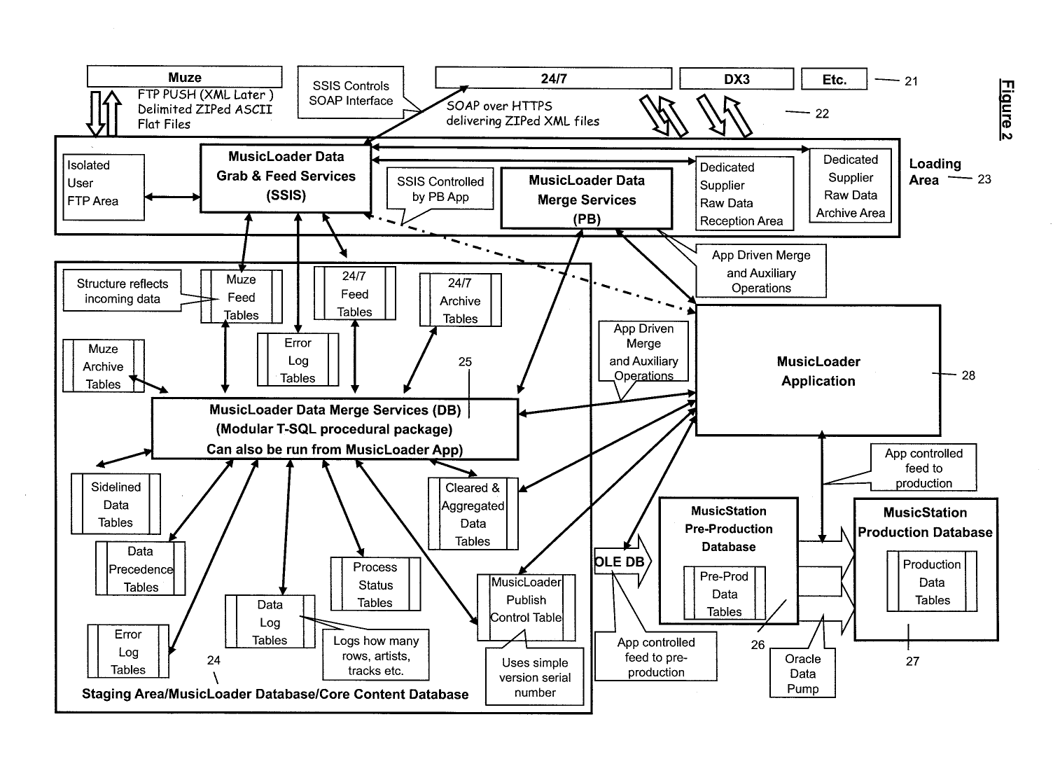

The phases of the ingestion and publication process are broken down below, and are illustrated in FIG. 2.

In FIG. 2, multiple data sources 21 (music labels, aggregators, such as Muze™, 24/7™, DX3™ and others), with a variety of supply/transport mechanisms 22 (such as FTP push, SOAP over HTTPS etc) indicated to show how their data is loaded into the loading areas 23. There are various components within the loading area 23 as shown in FIG. 2. The staging areas 24 are shown in the large database in the lower left, the “file” process boxes within which illustrate the various staging areas utilised in the preferred embodiment in order to cleanse the data which is then merged into the Data Merge Services database 25. The cleansed data is then loaded into a pre-production database 26 and then production databases 27 for testing and then distribution respectively. The MusicLoader application window 28 illustrates the handling of data which has been flagged for manual confirmation/cleanup.

Each stage in the staging area 24 consists of a tools-supported manual process, whereby the tools analyse the metadata from the various sources available and, where possible, automatically identify duplicated data (i.e. descriptive metadata entries which refer to the same piece of digital media) and some items are flagged for manual correction where the automated process does not have sufficient information available from the data sources to perform a de-duplication and consolidation automatically.

Incoming data to be ingested may arrive in a variety of different forms, including XML of differing formats (according to the internal standards of the source data holder), plain text files and Excel spreadsheets. All such formats are loading in a Loading Area 23 and are then passed through a variety of Staging Areas 24, each of which increases the standardisation of that metadata. In the description of the process which follows, the various types of analysis, transformation and de-duplication of metadata is presented as if it takes place within a single Staging Area prior to ingesting the cleansed data into a production database for distribution and use. In the preferred embodiment, those actions take place across multiple Staging Areas, each utilising its own data store.

Supplementary data—such as images and digital media files—may accompany metadata, and needs to be analysed and, if necessary, transcoded where appropriate. For example, in the preferred embodiment the track duration specified in metadata would be cross-checked against the track duration extracted from the actual digital media file as one method of validating the metadata.

Incoming data is cleansed by checking for common typographical/transcription errors—such as transposed letters and variant spellings (such as US and UK English)—and by comparison to a known clean dataset, where possible.

The known clean dataset is a reference database which includes information, which is known to be accurate, concerning variant artist names—for example, that “George Scott” and “George C. Scott” refer to the same artist—together with variant album titles and other hints to assist with data de-duplication and cleansing. As additional volumes of metadata are ingested and cleansed, the reference database increases in size and coverage accordingly, essentially permitting the system to “learn” from previous data ingestion experiences.

Where data is provided from multiple different sources, the tool compares the different versions and selects the “correct” metadata item based on a majority-vote system, weighted according to the information available in the reference database.

For example, suppose that three data sources provide information about a given track, the incoming data may be as given in the table below, the FINAL column of which indicates the final data selected for inclusion by the tool:

| | Source A | Source B | Source C | FINAL |
|---|---|---|---|---|
| Artist Name | George | George | George | George |
| | Michael | Micheal | Michael | Michael |
| Track | 03 | 01 | 01 | 01 |
| Number | | | | |
| Track Title | Older | Older | | Older |
| Duration | 3:22 | | 3:22 | 3:22 |
| Genre | Pop | Rock | Pop | Pop |

In the example above, it can be seen that Source A contains correct information for all elements except for the Track Number, while Source B and Source C contain incorrect or missing information in other fields. The reference database and transcription errors assessment protocols assist in identifying that Source B refers to the same track and the other two data sources, while majority voting ensures that the FINAL column picks up the best quality (i.e. the most common, and therefore most likely to be correct) metadata descriptions for each element.

Where a, user-configurable, threshold of similarity is reached (typically 65%-85% similarity in the preferred embodiment), the final data is flagged for manual confirmation before being passed into the core database for production use. Items which exhibit similarity values outside of that range are automatically discarded as being duplicates of existing content or passed automatically into the core database as having been clearly identified as new content.

The purpose of manual confirmation is to ensure that similar but interesting variants—such as a release of an album with additional bonus tracks—are preserved in the system, as well as to provide an additional check where automated analysis results in sufficiently ambiguous data as to require human judgement.

The threshold of similarity is calculated as a statistical function of the relationship between the FINAL data and the source data from which it was derived and by making use of the clean reference database disclosed previously, using a variety of fuzzy logic pattern matching techniques, including but not limited to one or more of the following, where the relevant data is available:
1. Cross-referencing of ISRC (International Standard Recording Code) values
2. Cross-referencing and checksum validation of UPC (Universal Product Code) values
3. The number of tracks in a given release or album
4. The duration of individual tracks within a release or album and the overall duration of that release or album
5. Pattern matching of artist names and track and album/release titles using a cleansed and simplified version of such text.
   That cleansing includes processes such as the stripping out of extraneous words (“the”, “and”, and so on), translation of accented characters into a standardised format for matching (for example, translating e-grave to a simple “e” for matching purchases) and standardisation of ambiguous strings, such as converting numeric sequences into equivalent words, or vice versa, to ensure that pattern matching is performed against generic standardised data, such as “19” rather than “nineteen” (or vice-versa in an alternative embodiment). The cleansing process is also, in the preferred embodiment, exception-aware, in order to ensure that unusual names, such as the band name “The The”, are specifically preserved.
6. The original release date, allowing for differing dates in different territories

During the data cleansing process, the procedure makes use of both a clean “reference database”, as described above, and also references the “core” content database, which in the preferred embodiment is the same database, though accessed for a slightly different purpose.

The core content database is accessed to distinguish new data—data which is not previously present in the core content database—from data updates when ingesting metadata from a data source. Similar fuzzy logic matching techniques are used to identify where incoming data is an update to an existing media content descriptor.

Such updates may constitute actual changes required to the metadata—such as a change of album title—or the “backfilling” of additional information about an existing album, track or other digital media release, whereby newly-ingested metadata is to be added to an existing metadata record.

During the ingestion process, such updates are subject to the same checks as provided for new metadata.

Content ingestion data is, in the preferred embodiment, recorded in audit database tables, for subsequent report generation. Recorded details include one or more of: artist, title, success or a reason for failure of the ingestion process for the item, a notation indicating whether this represents new, updated, backfilled or deleted items, the source(s) of the metadata and a notation as to which items of metadata were modified as a result.

This auditing provides both for rollback of a given ingestion, for report generation as to the published content available at any given time and for analyses to be performed to determine coverage of, for example, popular music or the contents of local or international charts in the currently published content database.

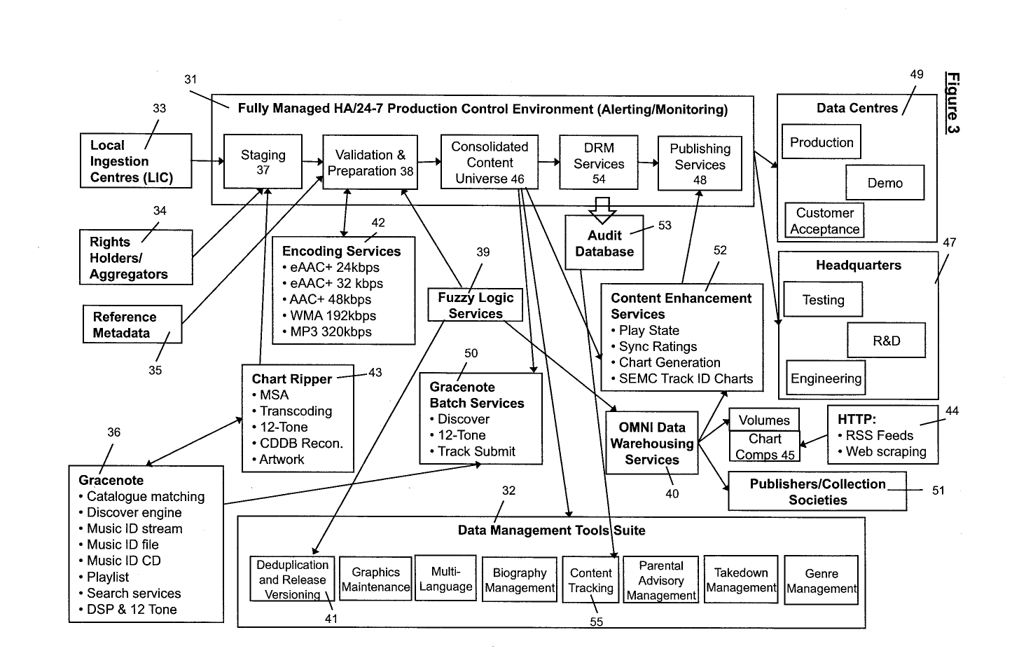

FIG. 3 illustrates the preferred embodiment of the overall process. Fully Managed HA/24-7 Production Control Environment (Alerting/Monitoring) 31—the flow inside this blue box is from left to right and illustrates the major stages of the process, as detailed in the text above.

Data Management Tools Suite 32—Each box indicates a particular type of metadata management required for the overall process of dealing with metadata. The only two which are directly relevant to this system are Deduplication and Release Versioning 41 and, for metering/reporting activities, the Content tracking 55.

The loading areas include:
Local Ingestion Centres (LIC) 33, which are loading areas used to ingest raw media file metadata for a specific territory.
Also included are the Rights Holders/Aggregators 34, which are the data sources (music labels, aggregators, etc).
Reference Metadata 35, which is the Additional specialised metadata source, used to provide enriched metadata such as cross-references between tracks for the purposes of recommendations.
Gracenote™ 36—A particular instantiation of a reference metadata provider, broken down to illustrate the kinds of metadata provided.

The overall process is that raw metadata is obtained from the loading areas 33, 34, 35 and 36 and reaches the various staging areas 37. That metadata is then cleansed (Validation and preparation 38) using Fuzzy logic services 39 including automatic cleansing using the reference database (OMNI data warehousing services database 40) and manual cleansing where indicated (Deduplication and Release Versioning 41). Also, any additional media file formats are produced by transcoding from a reference file, if necessary (Encoding services 42)

Additional metadata, such as Charts data, is obtained from reference metadata data sources (Chart Ripper 43) and from various additional source (HTTP 44, feeding into the Volumes/Chart Comps 45) and also ingested and consolidated/de-duped with the generally ingested metadata to form the Consolidated Content Universe 46.

The, now cleansed, data is then published to the pre-production (Headquarters 47) database for testing and then to the production databases (Publishing Services 48), leading to Data Centres 49. That data is accessible using a variety of services, such as the Gracenote™ Batch Services 50, and publishable to external locations (Publishers/Collecting Societies 51).

Content Enhancement 52 indicates the metering, reporting and data analysis procedures (track playing stats, synchronisation of user- and supplier-generated track ratings, the generation of charts and so on). The Audit Database 53 indicates the storage of metering/auditing data which feeds into that process. Finally, DRM services 54 is both the publication of the DRM-protected media files and the mechanism for generating the audit data for that Audit database 53.

### Metering and Reporting

In the main implementation, digital media files are made available from the main production database (e.g. database 27 in FIG. 2) for multiple consumer devices from a computer-based infrastructure. The consumer devices then meter the number of playbacks of a media file that last beyond a predefined extent, in order to generate metering data. The consumer devices then automatically report that metering data back to the computer-based infrastructure. All track plays/listens are reported from the consumer's device back to the server for optimisation of the engine and the overall infrastructure. In addition the metering data can be used:
to identify tracks which are not present on a digital media service for a given locale;
to identify tracks for further processing, such as identifying a need for the ingestion of additional or updated metadata for a one or more tracks; or provisioning one or more tracks to a user using a different digital media file format. The different digital media file format may utilises a form of DRM protection, or no DRM protection.
to recommend further media content to a specific user, where the metrics gathered about that user's media playing preferences are used to assist with calculations as to the user's likely preferences for watching, reading or listening to digital media content in the future.

In addition:
In the preferred embodiment, Metering is implemented differently on different devices and reported with different regularity based on connectedness.
Metering data for a consumer with more than one type of device (e.g. phone and PC) needs, in a typical example embodiment, to be created, collected and consolidated even though it comes from different platforms with different rules and formats.

In an example embodiment, the system supports the creation, collection, consolidation and administration of content usage metering files across multiple platforms and reporting facilities including, but not limited to calculating and reporting the complex financial and usage statistics to the plethora of stakeholders requiring reports in multiple territories. Stakeholders requiring reports include major music labels, independent music labels, content aggregators, publishing societies and business partners. In the preferred embodiment, the reporting analysis also provides highly sophisticated analysis such as churn analysis and subscriber behaviour reporting.

The core metering action in this system is the recording of a track play, or the playing of some other digital media file, such as a movie, a game, an article or a news story. For convenience, all such digital media content will be referred to herein as “tracks”, with defined collections of “tracks” being referred to as “albums” or “releases.”

The system identifies a track as having been played on a client device when some minimum portion of that track has been played, the minimum portion being configurable based on media type but in the case of music files would typically be either 4%-5% of the track length or 30 seconds. Track plays below the defined threshold would not be recorded for metrics or reporting purposes, since such brief plays may be generated by user's skipping past tracks.

The context of a track play is also recorded in the metrics. Contextual information includes, in an example embodiment, the album/release, playlist, chart or other context from which the played track originated as well as basic information including, but not limited to, one or more of: the client device on which the track was played, the user who played that track, the duration/proportion of the track which was in fact played and the internal session context of the track play, such as the tracks played immediately prior to or after that track.

Metering information (“metrics”) is gathered on the client device and is communicated to the server. The frequency and method of transport of metrics to the server is dependent on the type of device but, in the preferred embodiment, typical scenarios would include:
An always-connected high-bandwidth device, such as PC which is online, would typically send metrics to the server as soon as possible.
An intermittently-connected or low-bandwidth device, such as a mobile handset or a roaming in-car music system, would typically send metrics to the server at predefined intervals and/or according to specific triggers, such as “as soon as the client device detects that sufficient bandwidth is available.”

The method of transportation, in the preferred embodiment, is to piggyback the metrics on an existing communication which the client device would have had to send to the server in any event, such as a request for recommendations or for a media file or a polling event asking the server for messages to be delivered to the client device's inbox. Another example embodiment may send specific messages to deliver metrics, and that approach may be taken in the preferred embodiment if the client device has metrics but no other requests queued for sending to the server in excess of some configurable period of time (typically 60 minutes).

Metrics received by the server are, in the preferred embodiment, stored in auditing database tables. Such metrics may also be enriched with one or more items of additional metadata, including the genre, artist, era, music publisher, copyright holder, demographic information about the user, downloaded or streamed file sizes, bandwidth available to a client device at the time and any additional information about which reporting analyses are desired. In the preferred embodiment, metrics stored for reporting purposes are anonymised in order to protect the user's privacy.

A second major area for which metrics are recorded is that of user subscriptions and purchasing. Specifically, the system provides a mechanism whereby it is recorded when a user performs one or more of the following actions: signing up to a subscription service, purchasing one or more digital media files, modifying or cancelling a subscription or playing a preview of a track. All such requests made to the server are stored, suitably anonymised in the preferred embodiment, in the audit database tables for subsequent report generation.

The auditing database tables may then be used to generate reports, both internally and for third parties such as music labels or movie studios.

Typical reports generated by the present invention in its preferred embodiment include:
Subscriber churn reports, indicating the number of users who have signed up to or cancelled a subscription to a digital media service in a defined time period
Financial reports, indicating the royalties payable to a given media publisher for a specified period, based on track plays for a subscription service and/or track purchases for any digital media service
Realtime reports, indicating the activities being undertaken on a specific service at any given moment in time
Trend reports, indicating trends in, for example, music listening or movie watching preferences of users of a digital media service over time
Chart reports, indicating the most popular (by, for example, track plays, purchases or user- or critic-generated ratings) digital media files.
Subscriber usage reports, indicating the usage of a service by subscribers over time. For example, this may include details such as the number or size of tracks downloaded on a particular service
Community activity reports, indicating the volume of messages, recommendations and any other communications send via a “community” aspect of a digital media service

Reports may also, in the preferred embodiment, capable of being broken down by one or more of the following classifications: genre, adult content status, era, publication or other dates, artist, publisher, copyright holder, time period, chart rankings, director, writer/composer, client device type, digital media service or any other stored metadata.

Numeric details may be presentable as overall figures, averages, medians, some other statistical measure or a combination thereof. The reporting period, the format of generated reports and the frequency with which they are generated is also, in the preferred embodiment, configurable.

Report formats may be updated frequently, typically used for realtime reports which may update at intervals defined in seconds or fractions thereof, or generated as documents intended for viewing on a computer or for printing.

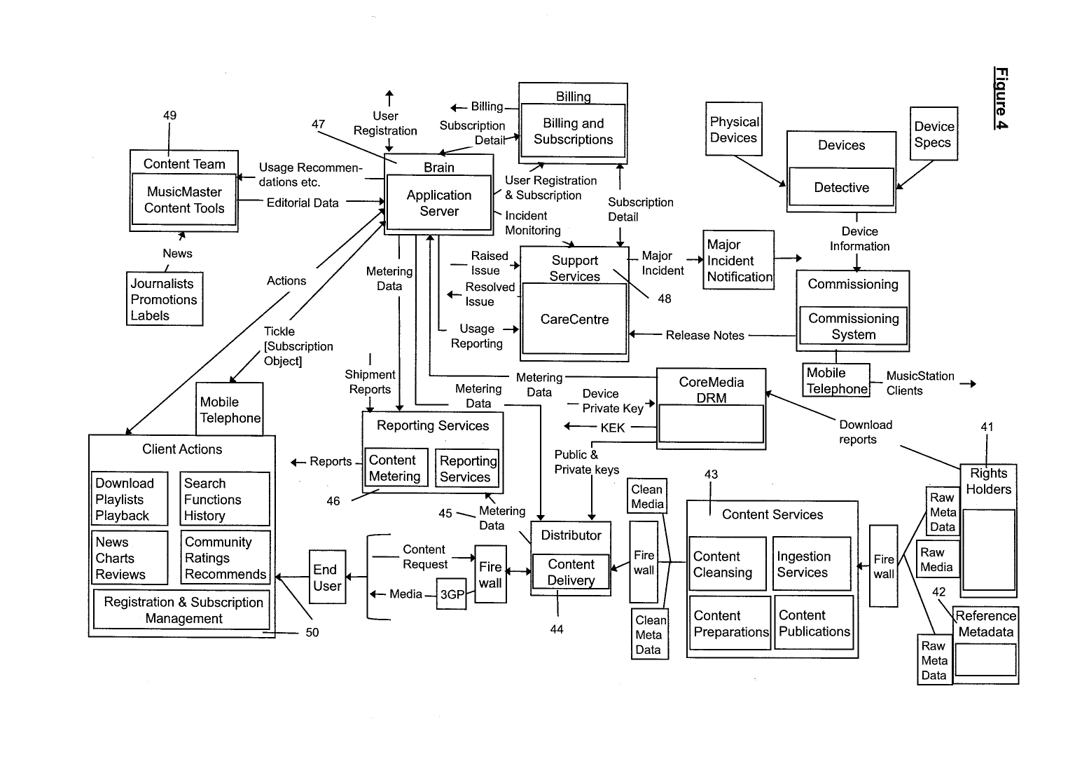

FIG. 4 schematically depicts the overall flow. The content ingestion engine is shown and operates as described above, with content from rights holders 41 (e.g. music labels) and third party metadata sources 42 providing media files and related metadata to a content ingestion engine that removes errors, inconsistencies and duplicates and also consolidates and prepares the media files for a distribution server 44. Metadata coverage and track availability metrics 45 are provided by distribution server to a reporting services engine 46 that generates the reports described above. Digital media play data is collected by a software application running on the client (i.e. consumer) devices 50; this includes the track/play metering data described above that records which tracks have been actually played by the consumer for more than a predefined extent. This metering data is fed to the application server 47, which in turn feeds the metering data to the reporting services engine 46. Metering data is also sent to the distribution server 44, schematically representing the use of the metering data to optimise the delivery infrastructure and the ingestion services engine 43 and also to, as noted above:
identify tracks which are not present on a digital media service for a given locale;
to identify tracks for further processing; or provisioning one or more tracks to a user using a different digital media file format.
to recommend further media content to a specific user.

Application server 47 uses the metering data to provide usage reporting to support services 48. User recommendations are also made based on gathered playing metrics, using Content Team tools 49.

1. A method of metering the use of digital media files, comprising the steps of:
(a) making available digital media files for multiple consumer devices from a computer-based infrastructure;
(b) a consumer device metering the number of playbacks of a media file that last beyond a predefined extent, in order to generate metering data;
(c) that consumer device then automatically reporting that metering data back to the computer-based infrastructure.

2. The method of claim 1 in which the computer-based infrastructure uses the metering data to optimise the handling and delivery of media files.

3. The method of claim 1 in which the metering data is used to identify tracks which are not present on a digital media service for a given locale.

4. The method of claim 1 in which the metering data is used to identify tracks for further processing.

5. The method of claim 4 where the further processing involves identifying a need for the ingestion of additional or updated metadata for one or more tracks.

6. The method of claim 4 where the further processing involves provisioning one or more tracks to a user using a different digital media file format.

7. The method of claim 6 where the different digital media file format utilises a form of DRM protection.

8. The method of claim 6 where the different digital media file format utilises no DRM protection.

9. The method of claim 1 in which the metering data is used to recommend further media content to a specific user, where the metrics gathered about that user's media playing preferences are used to assist with calculations as to the user's likely preferences for watching, reading or listening to digital media content in the future.

10. The method of claim 1 in which the predefined extent of the playback is configurable.

11. The method of claim 10 in which the predefined extent of the playback is selected to be sufficiently long to distinguish a user playing a track from a user skipping past tracks.

12. The method of claim 1 in which the computer based infrastructure reports the metering data to the holders of the rights in the media files or their agents.

13. The method of claim 1 in which the computer-based infrastructure uses the metering data to generate reports.

14. The method of claim 13 in which the reports are subscriber churn reports, indicating the number of users who have signed up to or cancelled a subscription to a digital media service in a defined time period.

15. The method of claim 13 in which the reports are financial reports, indicating the royalties payable to a given media publisher for a specified period, based on track plays for a subscription service and/or track purchases for any digital media service.

16. The method of claim 13 in which the reports are realtime reports, indicating the activities being undertaken on a specific service at any given moment in time.

17. The method of claim 13 in which the reports are trend reports, indicating trends in, for example, music listening or movie watching preferences of users of a digital media service over time

18. The method of claim 13 in which the reports are chart reports, indicating the most popular digital media files.

19. The method of claim 13 in which the reports are subscriber usage reports, indicating the usage of a service by subscribers over time.

20. The method of claim 13 in which the reports are community activity reports, indicating the volume of messages, recommendations and any other communications send via a “community” aspect of a digital media service.

21. The method of claim 13 in which the reports are broken down by one or more of the following classifications: genre, adult content status, era, publication or other dates, artist, publisher, copyright holder, time period, chart rankings, director, writer/composer, client device type, digital media service or any other stored metadata.

22. The method of claim 1 in which the metering data also includes contextual information relating to the playback of a file.

23. The method of claim 22 in which the contextual information includes one or more of: the album/release, playlist, chart or other context from which the played track originated

24. The method of claim 22 in which the contextual information includes one or more of: the client device on which the track was played, the user who played that track, the duration/proportion of the track which was in fact played and the internal session context of the track play, such as the tracks played immediately prior to or after that track.

25. The method of claim 1 in which the frequency and method of transport of metering data to the infrastructure is dependent on the type of consumer device.

26. The method of claim 25 in which an always-connected high-bandwidth consumer device sends the metering data to the server as soon as possible.

27. The method of claim 25 in which an intermittently-connected or low-bandwidth consumer device sends metering data to the server at predefined intervals and/or according to specific triggers.

28. The method of claim 1 in which the data stored at the infrastructure is enriched with one or more items of additional metadata selected from the list: the genre, artist, era, music publisher, copyright holder, demographic information about the user, downloaded or streamed file sizes, bandwidth available to a client device at the time.

29. The method of claim 1 in which the metering data includes when a user performs one or more of the following actions: signing up to a subscription service, purchasing one or more digital media files, modifying or cancelling a subscription or playing a preview of a track.

30. A system for metering the use of digital media files, including:
(a) a computer-based infrastructure making available digital media files for multiple consumer devices;
(b) a consumer device programmed with software to (i) meter the number of playbacks of a media file that last beyond a predefined extent, in order to generate metering data and to then (ii) automatically report that metering data back to the computer-based infrastructure.

31. The system of claim 30, further adapted to perform the method of any preceding method claim.
